(19) United States
(12) Patent Application Publication
(10) Pub. No.: US 2012/0022907 A1
(43) Pub. Date: Jan. 26, 2012

(54) SOCIAL NETWORKING IN AN ASSET PERFORMANCE MANAGEMENT SYSTEM

(75) Inventor: Eric S. Fidler, The Woodlands, TX (US)

(73) Assignee: ROCKWELL AUTOMATION TECHNOLOGIES, INC., Mayfield Heights, OH (US)

(21) Appl. No.: 12/841,566

(22) Filed: Jul. 22, 2010

(51) Int. Cl. G06Q 10/00

(52) U.S. Cl. 705/7.14; 705/7.38

(57) ABSTRACT

Systems and methods are provided that link automation asset analytics with social networking. Automation asset performance is monitored and analyzed in view of one or more asset application models, and asset performance anomalies or inefficiencies are identified. Asset performance management data generated by the analysis is used to search a repository of expert consultants, and one or more suitable consultants having requisite expertise to assist with the identified asset performance issues are identified. In some embodiments, the asset performance management data is forwarded to the selected consultants in order to convey the nature of the asset performance issue.

### TECHNICAL FIELD

The claimed subject matter relates generally to automation systems, and more particularly to a system and method for intelligent social networking between automation asset owners and knowledgeable consultants using asset performance management data.

### BACKGROUND

Industrial control and monitoring systems are at the heart of today's process control and manufacturing environments. These systems can comprise a number of diverse automation assets working alone or in conjunction with one another, such as industrial controllers and their associated I/O devices, motor drives, motion controllers, PID controllers, vision systems, competitive distributed control systems, condition-based monitoring systems, and the like. The ongoing evolution of these automation assets has resulted in a commensurate increase in overall system complexity, but, advantageously, has also made larger amounts of asset performance data available for optimization and management of plant systems. With the growing number of equipment configuration options and a widening range of equipment capabilities, configuration and maintenance of modern automation systems can require a specialized level of asset expertise that is often outside the experience of on-site plant personnel, who are generally responsible for maintaining a diverse spectrum of process and manufacturing equipment. Because of the range and diversity of the automation assets in their charge, plant engineers and technicians often possess, at most, a generalized understanding of a broad range of equipment types and manufacturers, rather than an in-depth familiarity with a given asset. Frequent personnel turn-around due to retirement, down-sizing, or pursuit of other employment opportunities further contributes to this lack of in-house asset knowledge as experienced personnel leave the facility, taking their system expertise with them.

Given the difficulties cultivating and maintaining in-house asset expertise, industrial facilities are increasingly reliant on outside support for configuration, repair, or maintenance of their automation assets. This support can be provided by the equipment manufacturers themselves, who often maintain a dedicated technical support staff to assist customers with configuration or performance issues. System integrators and other outside contractors also provide technical support and engineering services to asset owners. However, selecting an appropriately knowledgeable consultant for assistance with a given asset performance problem can be difficult, since a potential consultant's level of experience in dealing with a particular asset performance problem cannot always be ascertained with certainty. Moreover, lack of technical expertise on the part of the asset owner can hinder accurate communication of the particulars of a given asset problem to a potential consultant.

In view of the difficulties associated with maintaining a facility's assets without sufficient in-house expertise, it would be desirable to have a mechanism that leverages automated asset performance analytics to facilitate social networking with one or more suitable outside consultants.

### SUMMARY

The following presents a simplified summary in order to provide a basic understanding of some aspects described herein. This summary is not an extensive overview nor is intended to identify key/critical elements or to delineate the scope of the various aspects described herein. Its sole purpose is to present some concepts in a simplified form as a prelude to the more detailed description that is presented later.

One or more embodiments of the present disclosure relate to systems and methods for networking plant personnel with knowledgeable consultants having a requisite level of expertise with one or more process or manufacturing assets of interest (e.g., automation assets, compressors, filters, conveyors, pumps, machines, etc.). To this end, a social networking infrastructure is provided that facilitates intelligent social networking between a client having an asset performance concern and one or more professionals with relevant experience to provide needed support.

The social networking infrastructure can include a repository of knowledgeable consultants (engineers, technical support personnel, systems integrators, etc.). Consultant information stored in the repository can include a detailed accounting of the respective consultant's technical areas of expertise, equipment manufacturers with which the consultant has experience, third-party certifications, and other information that can be employed to intelligently match the consultant with a specific need relating to an asset performance issue.

In order to reduce the knowledge burden on the customer, one or more embodiments of the social networking infrastructure can leverage equipment performance data collected for the customer's system using an asset performance management (APM) system. The APM system can monitor an automation system using one or more predefined asset application models that are selected and configured in accordance with the customer's particular set of assets. The asset application models embody collective best practices, knowledge, and expertise relating to the assets being modeled, and provide a consistent baseline for how the assets comprising the system should be effectively monitored to yield high-value prognostic data tailored to the customer's particular application and industry. If the APM system detects an asset performance issue, generated APM data relevant to the performance issue can be submitted to the social networking system, and a list of outside consultants having the necessary expertise to address the issue can be provided to the client. Filtering the set of available consultants according to the particular nature of the asset performance problem can also mitigate time-consuming vetting of service providers who may not have the required experience to solve the problem at hand.

According to another aspect, the APM data generated by the APM system can be forwarded to one or more of the consultants identified as having suitable expertise to assist with the asset performance problem. In this way, a customer lacking experience in diagnosing a particular automation asset need not make a determination regarding what information should be provided to an outside consultant in order to convey the nature of the problem needing addressed

To the accomplishment of the foregoing and related ends, certain illustrative aspects are described herein in connection with the following description and the annexed drawings. These aspects are indicative of various ways which can be practiced, all of which are intended to be covered herein. Other advantages and novel features may become apparent from the following detailed description when considered in conjunction with the drawings.

### BRIEF DESCRIPTION OF THE DRAWINGS

FIG. 1 is a high-level block diagram of a social networking infrastructure.

FIG. 2 illustrates exemplary inputs and outputs with respect to an asset performance management social networking system.

FIG. 3 illustrates an exemplary system that leverages asset performance management data to facilitate networking asset owners with consultants.

FIG. 4 is a block diagram illustrating selection an APM model for use in an asset performance management system.

FIG. 5 illustrates an exemplary data record for storing a consultant's information and areas of expertise in a consultant repository.

FIG. 6 is a data flow diagram illustrating generation of asset performance keywords.

FIG. 7 is a high-level block diagram illustrating an exemplary system for conveying APM analysis data to a consultant.

FIG. 8 illustrates an exemplary hierarchical architecture of APM systems in connection with a social networking architecture.

FIG. 9 is a flowchart of an example methodology for identifying suitable technical consultants to assist with an asset performance issue.

FIG. 10 is flowchart of an example methodology for employing asset performance data to solicit for offers of service from one or more technical consultants.

FIG. 11 is a flowchart of an example methodology for registering a consultant for eligibility to receive APM data from an asset owner.

FIG. 12 is a flowchart of an example methodology for automatically refining a consultant search based on an asset owner's role and location.

FIG. 13 is a flowchart of an example methodology for initiating a live dialog with an expert consultant for assistance with an asset performance problem.

FIG. 14 is an example computing environment.

FIG. 15 is an example networking environment.

### DETAILED DESCRIPTION

The present invention is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

It is noted that as used in this application, terms such as “component,” “module,” “model,” and the like are intended to refer to a computer-related entity, either hardware, a combination of hardware and software, software, or software in execution as applied to an automation system for industrial control. For example, a component may be, but is not limited to being, a process running on a processor, a processor, an object, an executable, a thread of execution, a program and a computer. By way of illustration, both an application running on a server and the server can be components. One or more components may reside within a process and/or thread of execution and a component may be localized on one computer and/or distributed between two or more computers, industrial controllers, and/or modules communicating therewith.

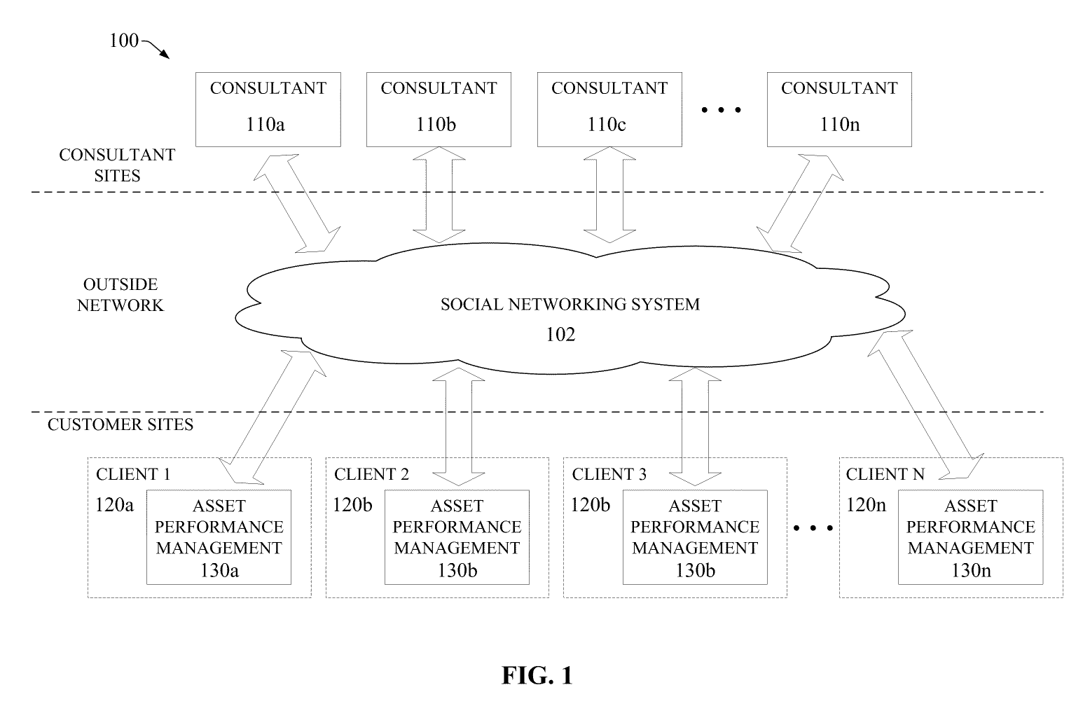

FIG. 1 illustrates a general overview of a social networking architecture, depicting exemplary relationships between clients 120a-120n seeking information or assistance in connection with asset performance issues and consultants 110a-110n seeking to provide information or services. Social networking system 102 is employed to intelligently connect clients 120a-120n with one or more suitable consultants selected from a pool of registered consultants 110a-110n. Selection of a suitable consultant for a given asset performance issue can be based in part on information relating to the asset performance issue provided to the social networking system 102 by the client.

Clients 120a-120n can comprise workstations, human-machine interfaces (HMIs), portable devices, or other user interface devices residing in respective customer sites (e.g. manufacturing plants, batch processing facilities, material handling warehouses, etc.). A client can be uniquely associated with a particular employee within the facility, a line or subsystem within the facility, or the facility in general. In the case of user-specific clients, the user's role and context can be employed by the social networking system as addition consultant filtering criteria. Consultants 110a-110n can comprise independent contractors, system integrators, equipment manufacturers, technical support staff, in-house engineers or maintenance staff, or other individuals wishing to be engaged to provide engineering services or technical support to clients. Consultants wishing to network with customers can register with the social networking system to become eligible for consideration. The social networking system 102 can provide a means for connecting clients 120a-120n with one or more consultants having the necessary experience to address specified asset performance issues experienced at the client site.

In order to generate meaningful asset performance data that can be leveraged by the social networking system 102 to intelligently match clients with suitable consultants, clients 120a-120n can work in conjunction with respective asset performance management (APM) systems 130a-130n. Each APM system 130a-130n can employ one or more predefined or custom configured models of the client's asset application to capture, validate, and interpret data from the assets, as will be discussed in more detail below. APM data generated by APM systems 130a-130n can be submitted to the social networking infrastructure to facilitate intelligent selection of consultants having the requisite knowledge and experience to solve asset performance problems identified by APM analysis. The models employed by the APM systems 130a-130n can encode collective best practices, knowledge, and expertise targeted toward the customer's particular automation assets or asset application. Employing such targeted APM systems to automatically generate relevant asset performance data for submission to the social networking system can ensure that a suitably knowledgeable subset of consultants are presented to the client for possible engagement. Moreover, the social networking system can forward the submitted asset performance data to the selected consultants for assessment. This can ensure that the potential consultants are provided with detailed information necessary to assess the customer's particular asset performance problem, while reducing the burden on the potentially untrained asset owner to communicate the nature of asset performance issues to the consultant.

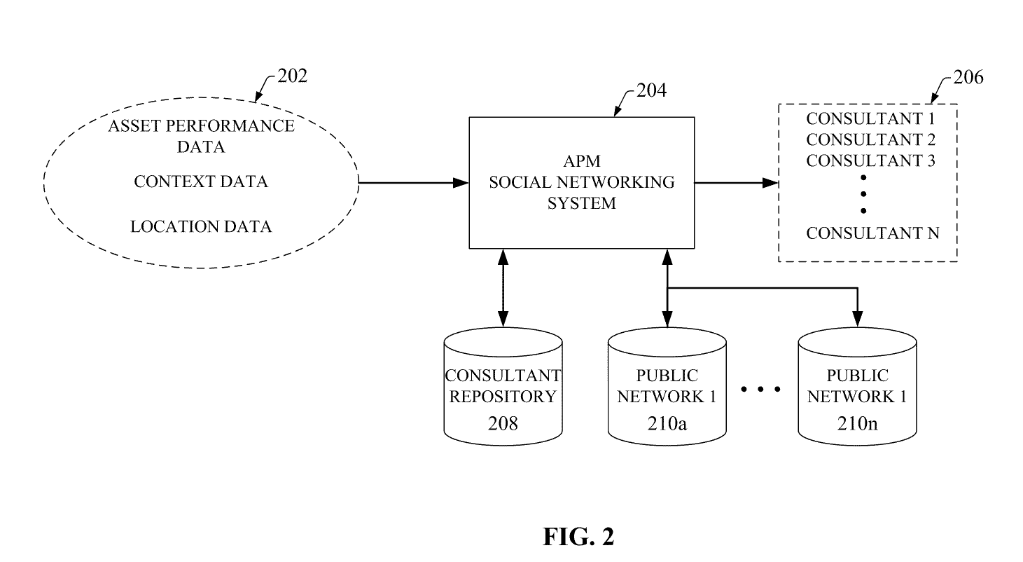

FIG. 2 depicts a general block diagram illustrating exemplary inputs and outputs with respect to the APM social networking system. APM social networking system 208 can receive input data 202 from a client requiring assistance with a particular asset performance problem or inefficiency. This input data 202 can include, for example, asset performance management (APM) data generated at the client site in accordance with techniques described infra. This APM data can include raw performance data collected for the automation assets, as well as refined data generated by the client's APM system based on this collected data. Inputs 202 can also include supplemental context data relating to factors that are external to the assets themselves but relevant to the performance of the assets, such as the industrial application in which the assets are being used, the performance of separate but related systems, etc. Additionally, inputs 202 can include a location of the assets (e.g., the location of the client facility). APM social networking system 204 can search a consultant repository 208 using input data 202 as criteria and retrieve a selected subset of consultants having the requisite expertise to assist with the asset performance problem. APM social networking system 204 then outputs a ranked and filtered list of such consultants 206 for presentation to the client. The client can reference the list 206 to select a suitable consultant for engagement to assist with the identified asset performance problem. Additionally, public networks 210a-210n can be searched in order to locate suitable consultants who are not registered in repository 208, in order that invitations to join the APM social network can be sent to such unregistered consultants.

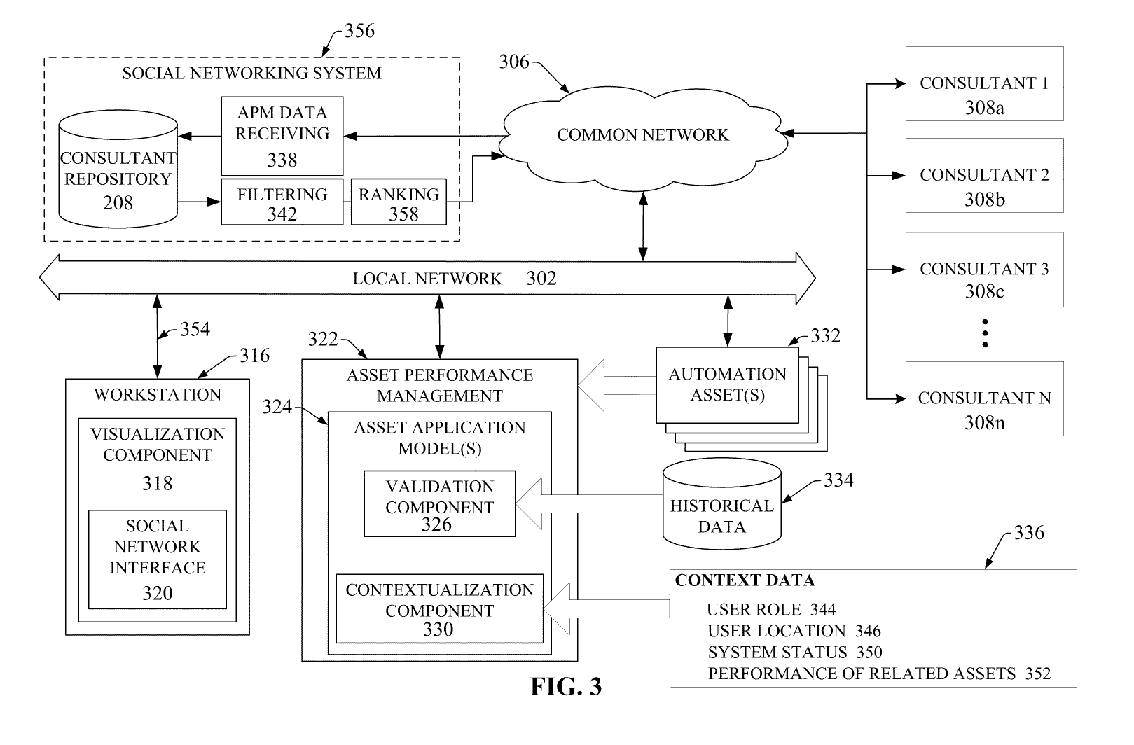

FIG. 3 depicts an exemplary system that leverages asset performance management data to facilitate networking between asset owners and consultants having requisite knowledge and experience to address identified asset performance problems. An automation system for carrying out an industrial application can comprise one or more automation assets 332. Exemplary industrial applications controlled and/or monitored by the automation assets 332 can include, but are not limited to, manufacturing processes, batch processes, material handling operations, packaging, fluid control, data collection, quality verification, or other such applications. Automation assets 332 can comprise equipment used to monitor and/or control such industrial processes and can include controllers and associated I/O, motor drives, variable frequency drives (VFDs), telemetry devices, human-machine interfaces (HMIs), networking equipment, communication devices, industrial robots, safety devices, SCADA systems, vision systems, and the like. Automation assets 332 can comprise a single device or a plurality of devices working in conjunction to carry out a defined industrial application.

The system depicted in FIG. 3 includes an asset performance management (APM) system 322. APM system 322 is communicatively coupled to the automation assets 332 via local network 302, although it is to be appreciated that a direct hardwired connection between the APM system 322 and automation assets 332 is also possible. APM system 322 captures, validates, and interprets performance data generated by the assets 332 as they carry out their designated industrial application. The APM system 322 collects and analyzes this data in view of one or more asset application models 324 (also referred to as APM models) that are selected and tailored to the particular assets 332 or asset application being monitored. Asset application models 322 encode collective best practices, knowledge, and expertise with respect to the automation assets 332 being monitored (e.g., a motion controller, VFD, PID controller, vision controller, etc.), the particular application being carried out by the assets (e.g., a stamping press application, a conveyor control system, a batching operation, etc.), and/or the industry to which the collective assets are directed (e.g., oil and gas, automotive, food and drug, plastics, etc.) Asset application models 324 can provide a consistent baseline for how an asset or asset application should be effectively monitored to yield meaningful performance data that can be used to identify or predict asset performance problems or inefficiencies.

It is also to be appreciated that the asset application models 324 can take into account the particular industry in which the assets 332 are employed. For example, a system comprising a set of coordinated automation assets 332 directed toward an oil and gas related application may need to be monitored and analyzed differently than the same collection of assets executing a batch operation in a food processing application. The asset model(s) 324 can be selected and configured to not only match the assets 332 in use, but also the particular industry in which the assets 332 are utilized.

In a non-limiting example, an asset performance model 324 used to monitor a variable frequency drive (VFD) that controls operation of a conveyor motor can inform the APM system 322 which VFD parameters should be monitored to determine optimal performance of the conveyor system under a range of conveyor conditions (e.g., a range of conveyor speeds, weight variations on the conveyor, etc.). This exemplary asset application model 324 can also define a range of values at which these crucial VFD parameters should be operating for each condition in the range of defined conveyor conditions. Exemplary asset application model 324 can further encode knowledge of known performance issues associated with particular undesirable parameter values detected during a given conveyor condition, as well as countermeasures that can be implemented to correct or improve a given performance issue. In the present example, the countermeasures can include a recommended VFD tuning operation, one or more recommended parameter adjustments, or recommended structural modifications external to the VFD (e.g. a mechanical adjustment to the conveyor itself). Using this encoded knowledge, the exemplary asset model 324 can instruct the APM system 322 how the VFD and associated control devices should be monitored (e.g., which parameters should be collected) and how the collected data should be analyzed in order to detect current or potential asset performance problems or inefficiencies. It is to be appreciated that the present system is not limited to monitoring of VFDs or conveyor systems in particular, but rather can be applied to any conceivable collection of automation or plant assets carrying out any given control, monitoring, or manufacturing and processing application.

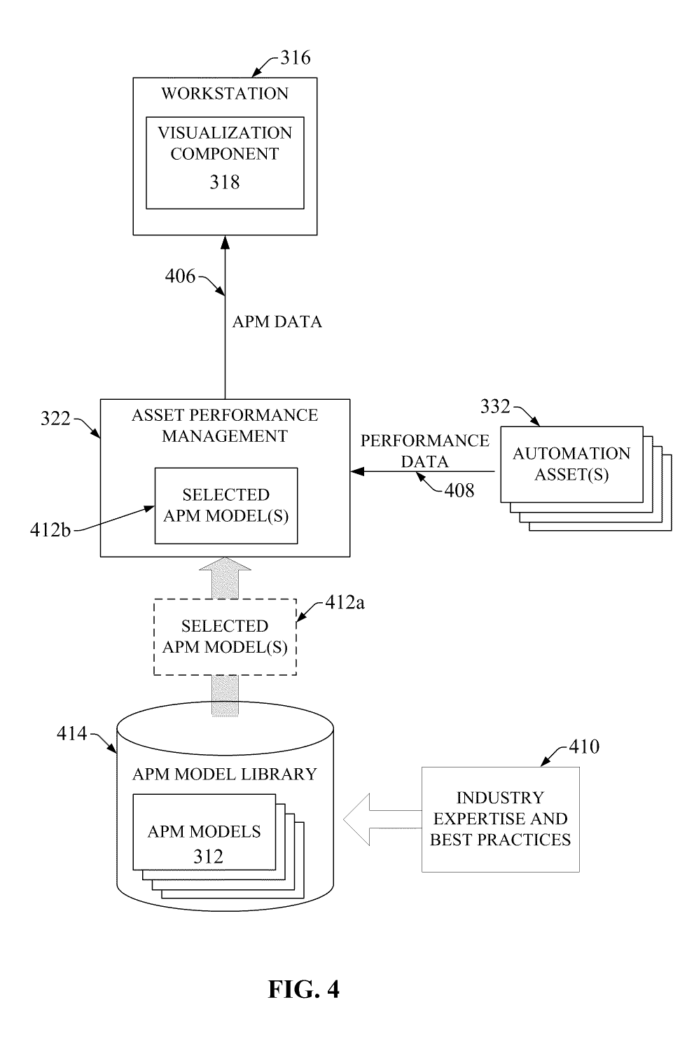

Turning briefly to FIG. 4, an APM model library 414 is illustrated. APM model library 414 is a repository for APM models 312 that are predefined for specific assets or asset applications. Predefined APM models 312 can include models for asset applications incorporating specific types of equipment, such as intelligent drives, integrated motion controllers, etc. The APM models 312 maintained in APM model library 414 capture industry expertise and best practices 410 with respect to the modeled assets and asset applications, and optimal performance thereof. Given a particular automation application utilizing assets 332, one or more appropriate APM models 412a can be selected from APM model library 414, and, if necessary, configured for use with the particular asset application to be monitored. The selected and configured APM model 412b can then be employed in APM system 322 to facilitate intelligent performance monitoring of assets 332. By providing an asset owner with access to the specialized information encoded within the predefined APM models 312, the asset owner can easily implement sophisticated asset performance monitoring without a high degree of personal technical expertise.

Returning now to FIG. 3, in order to capture a richer and more accurate data set catered to a particular industrial application, the asset application model(s) 324 can include a validation component 326 and a contextualization component 330. The validation component 326 and contextualization component 330 can provide specific rules for asset performance data validation and contextualization tailored to the particular asset or asset application represented by the model(s) 324. The validation component 326 can make a determination regarding a validity or accuracy of monitored asset data. The validity or accuracy can be determined based in part on the above-described asset knowledge encoded within the asset model 324. For example, turning once again to the exemplary conveyor system described above, the asset model(s) 324 can inform the validation component 326 that for a given weight loading on the conveyor, certain ranges of values are expected for respective VFD operating parameters (e.g. torque, speed, ramp up time, motor temperature, etc.). If the validation component 326 detects a VFD operating parameter falling outside its expected operational range as determined by the model(s) 324, the validation component 326 can instruct the APM system 322 to resample the anomalous parameter or to begin sampling the anomalous parameter at an increased sampling rate before allowing the APM system 322 to conduct performance analysis on the data.

Validity of the monitored asset data can also be based in part on historical data 334 previously collected for the automation assets 332. Validation component 326 can employ historical data 334 to infer valid or expected value ranges for the asset parameters being monitored, and can assess the validity of monitored real-time asset data in view of these inferred ranges. These inferred ranges can be dynamically adjusted by the APM system 322 as more historical data 334 is collected for the asset. The validation component can employ one or both of the historical data 334 and the expert knowledge embodied within the asset model(s) 324 to determine a validity of monitored asset data before allowing the APM system 322 to perform APM analysis on the data. The APM system 322 can use this validated data to provide reliable and accurate asset performance monitoring and analysis.

Once the asset performance data has been validated by the validation component 326, APM system 322 analyzes the validated asset performance data captured in accordance with the asset model(s) 324 as described above, and generates performance metrics (e.g., APM data) for the automation assets and their associated industrial application. APM system 322 processes the captured asset performance data in accordance with the asset model(s) 324, which can define appropriate analytics operations to be performed on the captured performance data to yield high value performance metrics for the particular assets 332 and/or industrial application being carried out by assets 332. The analysis can be customized in part as a function of supplemental contextual information relating to operation of the assets 332, their associated industrial application, the role of the user requesting the analysis, performance of related assets, or other external factors relevant to the current context of assets 332. Contextual information can be provided to the asset model(s) 324 in the form of context data 336. Asset model(s) 324 can include a contextualization component 330 that defines a set of rules for contextualizing performance data captured for the asset(s) being monitored. Contextualization component 330 utilizes context data 336 and the set of rules to model a current context for the asset performance data captured by APM system 322. This context data 336 can be used by contextualization component 330 to refine the performance data analysis carried out by APM system 322, or to visualize the results of the analysis in accordance with a role or location of the user requesting the asset performance analysis.

Context data utilized by asset model 324 can include, but is not limited to, user role data 344, user location 346, system status 350, or performance of related assets 352. For example, user role 344 can be employed by the APM system 322 to visualize results of the APM analysis in a format appropriate to the role and expertise of the recipient. If the recipient is an operator with a low level of asset understanding or expertise, APM system 322 can APM data (e.g., results of the APM analysis) in the form of plain language alarms or informational text tailored to the operator's assumed level of understanding given user role data 344. Alternatively, if user role data 344 implies a higher level of knowledge or expertise with regard to the monitored assets 332 (e.g. a technician or engineer), the APM results can be presented as raw data values, trending charts, or asset configuration recommendations presented at a level of technical detail commensurate with the indicated role. This role-specific APM data can be delivered by the APM system 322 to a workstation for presentation to a user via visualization component 318 of workstation 316, described in more detail below.

User location data 344 can provide an indication of the user's current location within a plant or facility. In cases where APM data is presented to the user via a mobile workstation, this location information can correspond with the location of the mobile workstation itself. Similar to the user role, user location data 346 can be employed by APM system 322 to customize how results of the APM analysis are presented to the user. For example, if the user location 344 indicates that the intended recipient of the APM data is located near a particular set of assets, contextualization component 330 can present APM analysis results having particular focus on the assets within the recipient's proximity. This can include filtering out APM data relating to assets that are greater than a predetermined distance from the recipient, or providing APM data at a higher level of granularity for assets within a predetermined distance from the recipient than for assets that are outside this predetermined distance.

System status data 346 can refer to an operating mode or current operating condition of the system comprising the assets 332. Asset application models 324 can take into consideration that expected operating parameters for an asset can vary depending on the current operating mode or status of the asset application. For example, in a stamping press application driven by a motor drive, expected status parameters for the drive (e.g., load on the motor, speed, torque, etc.) can vary depending on the particular product type being run through the press. Similarly, a VFD driving a conveyor will have a different range of acceptable operating parameters for different weight loadings on the conveyor. Contextualization component 330 can receive system status data 350 and model the current status of the system, which in turn affects how APM system 322 interprets the monitored asset performance data.

In some cases, interpretation of performance data captured from assets 332 can depend on a current status or performance of related systems carried out by a different set of assets. For example, if automation assets 332 include a pump that delivers liquid product to a downstream process controlled and monitored by a different set of automation assets, abnormal operation of this pump may be attributable to a performance issue or fault condition at the downstream process (e.g., a leak at a receiving tank, a malfunctioning level sensor, an inoperable pump at the downstream system, etc.). To facilitate a holistic APM analysis of automation assets 332, data 352 relating to performance of related assets (such as those that carry out the downstream process) can be provided to APM system 322 and used by contextualization component 330 to enhance the APM analysis. APM system 322 can analyze captured data from automation assets 332 in view of this related asset performance data 352, as well as the expert knowledge encoded in the asset model(s) 324, to determine correlations between a performance issue experienced at a separate but related system and a performance issue detected for automation assets 332. Results of this analysis, which can take the form of alarms, informational messages indicating a root cause of a performance issue, trend charts, graphs, raw performance data, beneficial countermeasures, or other such information can be rendered at a workstation 316 via visualization component 318 in a format commensurate with the user's role, location, and level of asset expertise, as discussed above.

In addition to identifying current asset performance issues, the analysis performed by APM system 322 can perform prognostic analysis of the monitored asset performance data to predict future asset performance problems. Such prognostic analysis can leverage the asset knowledge and expertise encoded within the asset model(s) 324 to identify asset performance trends that are likely to lead to an eventual performance problem or asset failure.

As noted above, APM analysis results can be provided by APM system 322 to a user workstation 316 and rendered via a visualization component 318. Workstation 316 can comprise any suitable hardware device capable of presenting data to a user, such as a computer running visualization software, an HMI, a hand-held computing device, or other such devices. Workstation 316 can be a fixed-location device, such as a desktop computer, or a mobile device, such as a laptop or mobile phone. In an exemplary but non-limiting configuration, workstation 316 can interface with local network 302 through a hard-wired or wireless network connection 354, and can receive APM data from APM system 322 over local network 302 via connection 354. In another exemplary embodiment, APM system 322 can interface with the Internet, and workstation 316 can be located at a remote location outside the facility. According to this exemplary embodiment, APM system 322 can transmit the APM data to workstation 316 via the Internet, and workstation 316 can receive the APM analysis data through a wireless or hard-wired connection to the Internet.

Visualization component 318 can comprise any suitable mechanism for displaying data to a user, such as an HMI application, an object-oriented programming (OOP) object, an Active X component, a SCADA interface, a web browser, a custom visualization application, or other such components. According to an aspect of the present invention, visualization component can also include a social network interface 320. Social network interface 320 can facilitate access a social networking system 356 in order to identify and engage with outside consultants having requisite knowledge and experience to provide assistance with a particular asset performance issue identified by APM system 322. This social networking system 356 is discussed in more detail below.

Social networking system 356 can comprise one or more consultant repositories 208 that store information relating to individuals or businesses seeking consulting engagements within their respective areas of expertise. Consultant repository 208 can be maintained outside local network 302 and can be accessed through a common network 306, such as the Internet. Consultants 308a-308n wishing to be contacted for business engagements can interact with consultant repository 208 via external network 306 to register their respective information with the repository 208.

Consultants 308a-308n can comprise individual experts, system integrators, engineering contractors, technical support personnel for an equipment or software vendor, or virtually any individual or business seeking to provide technical services or support to automation asset owners. Consultants 308a-308n can register their basic information as well as their level of experience in one or more technical areas with the social networking system 356, and this information can be maintained in consultant repository 208.

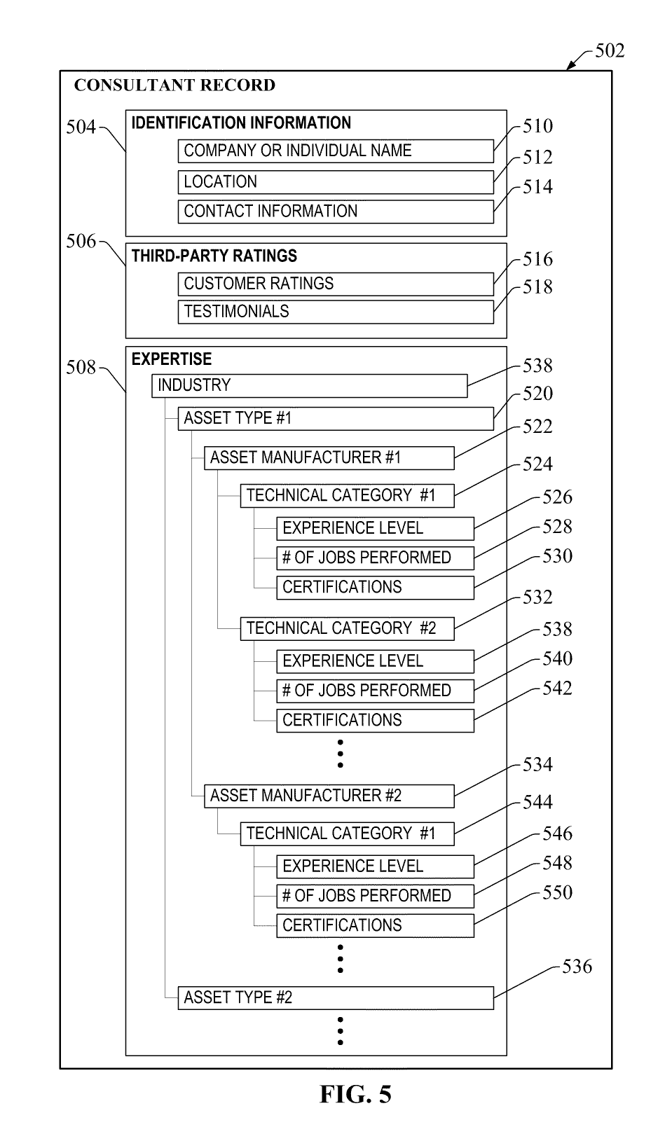

Turning briefly to FIG. 5, an exemplary data record 502 for storing a consultant's information and areas of expertise in consultant repository 208 is illustrated. Data record 502 is only intended to be illustrative, and it is to be appreciated that consultant repository 208 can store a consultant's information in virtually any format conducive to matching a customer's technical needs with the skill set and experience of the consultant. Data record 502 can comprise identification information 504, which can include data fields for identifying the consultant, such as the consultant's company or individual name 510, location 512, and contact information 514. The data record can also include third-party ratings 506, which can comprise, for example, customer ratings 516 and testimonials 518 submitted by previous customers who have engaged the consultants in the past.

Data record 502 can also include a detailed accounting of the consultant's expertise 508. This information 508 can be used by the social networking architecture to cross-reference the consultant's areas of expertise and experience with the particular needs of an asset owner as determined by the APM system 322 described above. Expertise data contained in data record 502 can be organized according to the industry or industries in which the consultant has experience. To this end, one or more industry fields 538 can be included representing the one or more industries in which the consultant has professional experience. Exemplary industries represented by industry field 538 can include automotive manufacturing, oil and gas, pharmaceutical, plastics, glass, electronic fabrication, waste water treatment, and other such industries. Industry 538 represents the broadest category of expertise associated with the consultant. For each industry field 538 listed for the consultant, data record 502 can include a detailed accounting of the particular asset types, equipment manufacturers or vendors, and technical categories in which the consultant has experience. In one or more embodiments, this information can be organized as a nested hierarchy under each industry field 538, as shown in FIG. 5.

Consultant expertise in each industry 538 can be organized by asset type, as illustrated by data fields 520 and 536. Asset type fields 520 and 536 can represent types or categories of automation assets with which the consultant has some degree of experience. Example asset types can include programmable logic controllers, motor drives, HMIs, PID controllers, soft controllers, vision systems, and the like. Asset types 520 and 536 can also include mechanical assets such as hydraulic or pneumatic cylinders, motors, conveyors, and other such mechanical assets.

For a given automation asset, there are typically multiple vendors or manufacturers offering their respective versions of the asset. Although there are often many commonalities between the versions of a given automation asset offered by different vendors, each vendor's version of the product can include a number of idiosyncrasies unique to that vendor's version of the asset. For example, although most PLCs execute ladder logic to monitor and control I/O devices, the particular programming environment used to configure the PLC and develop the ladder logic program can vary considerably depending on the PLC manufacturer, since PLC manufacturers often provide their own proprietary software to configure their equipment. The types of intelligent modules available for each brand of PLC can also vary. In another example, while there are many configuration and status parameters common to most VFDs, methods of configuration can vary considerably between vendors. As a result of these vendor-specific idiosyncrasies, expert knowledge of a particular vendor's asset does not necessarily translate to expertise with another vendor's version of the same type of asset, and consultants with extensive experience configuring or troubleshooting an automation asset manufactured by a particular vendor may not necessarily be best qualified to configure or troubleshoot a similar asset manufactured by a different vendor.

For these reasons, repository 208 can categorize the consultant's level of experience according to asset manufacturer. For each asset type 520 and 536 listed in exemplary data record 502, expertise information can be further classified according to manufacturer or vendor of the asset type, as represented by asset manufacturer fields 522 and 534. Classifying the consultant's knowledge in this way allows the social networking system 356 to recommend consultants having a requisite level of experience with the particular brand of automation asset in use by the customer.

Under each asset manufacturer field 522 and 534, the consultant's expertise information can be further categorized according to technical category for the asset type, as illustrated by technical category fields 524, 532, and 544. Technical category can refer to a particular function, feature, or aspect of the asset type for which service or advice can be provided. For example, if the asset type is a variable frequency drive, a technical category falling under this asset type can include tuning the drive, configuring the drive parameters, sizing a drive for a given motor or application, etc. Technical categories for a PLC asset type can include such functions as developing ladder logic for a particular control application, configuring a communication module associated with the PLC, troubleshooting a PID function block executing in the PLC, or other such technical aspects. The present disclosure is not limited to these examples, and virtually any type of automation asset and associated technical category can be categorized in data record 502 at a desired degree of granularity.

Additional information reflecting the consultant's knowledge of a given industry, asset type, manufacturer, and technical category can be catalogued under each technical category field 524, 532, and 544. This additional information can include, for example, a measure of the consultant's experience level for the given technical category, as represented by fields 526, 538, 546. The number of relevant jobs performed by the consultant can be logged in fields 528, 540, and 548. If the consultant has been professionally certified to perform work on a particular manufacturer's asset in the given technical category, such certifications can be noted in fields 530, 542, and 550.

It is to be appreciated that data record 502 described above is only one exemplary format in which consultant data can be stored in repository 208. Data record 502 can include different or additional data fields reflecting a consultant's level of experience and expertise with a particular asset or technical area. The data fields can be organized in any format suitable for cross-referencing a particular asset performance issue with a consultant's degree of expertise in the relevant technical area. Although data record 502 is depicted in a nested hierarchical format, non-hierarchical formats are also contemplated and are within the scope of the present disclosure.

Returning now to FIG. 3, consultants 308a-308n can register their information (e.g., the information described above in connection with FIG. 5) with consultant repository 208 via common network 306 (e.g., the Internet). Once registered, the consultants are eligible for discovery and selection in response to requests from a customer's social networking interface 320. As discussed above, results of an asset performance analysis carried out by APM system 322 can be rendered on visualization component 318 of workstation 316. These results can include identification of an asset performance anomaly, a predicted future component failure based on current asset performance conditions, an indication of an asset that is not operating at optimal efficiency and which can be improved by a tuning or reconfiguration operation, an alarm condition, or other such APM data. As discussed supra, this APM data can be generated based on an analysis of a single asset taken alone, or on collective performance of the set of assets 332 working in conjunction to execute an industrial application. Additionally, the APM results can be presented in a format targeted to the recipient's role and assumed level of understanding as determined by APM system 322, which can leverage context data 336 to make such a determination.

Once APM analysis results have been presented to the visualization component, a user can employ social network system 320 to access the social networking architecture 356. In particular, social network interface 320 can submit APM data generated by the APM system 322 to social networking architecture 356 via common network 306. The submitted APM information can include, for example, an identification of automation assets 332 in use, the type of industry in which the assets 332 are operating, identification of one or more asset performance issues identified by APM system 322, and any additional context data that may be relevant to diagnosing the identified performance issue. In response, social networking system 356 can identify one or more consultants having suitable credentials to provide assistance with the asset performance issue identified by APM system 322.

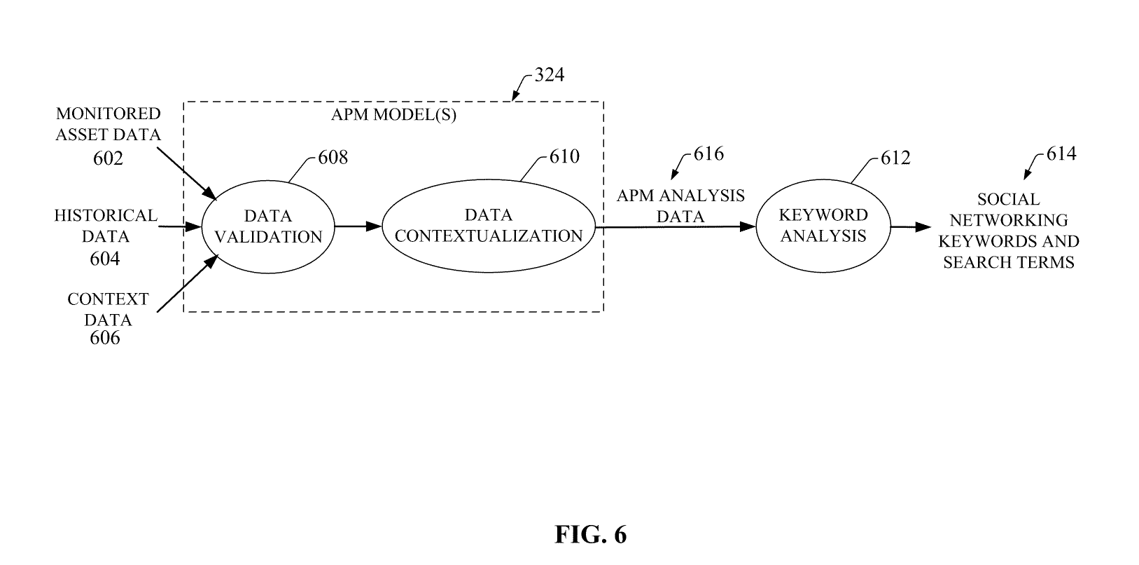

According to one or more embodiments, APM data submitted to the social networking system 356 can comprise keywords or search terms extracted or derived from the results of the analysis performed by APM system 322. Turning to FIG. 6, a data flow diagram illustrates a process for generating asset performance keywords that can be employed by the APM system 322 to search consultant repository 208 for qualified consultants. Monitored asset data 602, historical data 604, and context data 606 can be provided to APM system 322 executing one or more appropriate asset application models 324, as described supra. Data validation 608 and contextualization 610 can be performed on the received data using data validation component 326 and contextualization component 330, respectively. Validation and contextualization is performed in accordance with the particular asset application model(s) being executed by APM system 322, as discussed above. In particular, asset application model(s) 324 can be selected to correspond with the particular asset(s) or asset application being monitored, and can provide rules for monitoring, validating, and contextualizing the monitored asset data 602 in view of historical data 604 and context data 606. The validation and contextualization processes can yield refined asset performance metrics in the form of APM analysis data 616. APM analysis data 616 can also include identification of one or more detected or predicted asset performance problems or inefficiencies. APM system 322 can then perform a keyword analysis 612 on the APM analysis data 616 to extract or derive keywords 614 indicative of the asset performance issues. These keywords can include, but are not limited to, a type or class of asset experiencing the problem, a name of the vendor or manufacturer of the asset, an identifier describing the problem to be solved or a recommended countermeasure (e.g., “PID loop tuning,” “network reconfiguration,” “VFD setup,” etc.), and other such keywords describing the nature of the detected asset performance issue. The extracted or derived keywords 614 can then be submitted to the social networking system 356, which can used the keywords to search repository 208 and identify suitable consultants having requisite levels of experience with the performance issues identified by the keywords 614.

It is to be appreciated that keyword analysis is only one exemplary method of formatting APM data for submission to social networking architecture 356, and that other methods of APM data processing are contemplated and within the scope of the present invention. For example, high-granularity APM data can be submitted to social networking system 356 in the form of raw asset performance metrics generated by APM system 322, and these performance metrics can be leveraged by social networking system 356 to search for suitable consultants based on performance concerns inferred from the metrics.

Returning to FIG. 3, the APM data submitted by social network interface 320 can be provided to social networking system 356 and received by an APM data receiving component 338. APM data receiving component 338 can parse the submitted APM data to identify information that can be used to match one or more qualified consultants with the particular asset performance issue identified by APM system 322. APM data receiving component 338 can then cross-reference the identified asset performance issues and any relevant contextual information with the set of consultants registered with the consultant repository 208 to determine a subset of consultants having a requisite level of knowledge and experience to provide assistance with the identified asset performance issue. Selection of one or more consultants from repository 208 can be based in part on a comparison of the submitted APM data with the information detailing each potential consultant's level of relevant experience stored in repository 208 (described above in connection with FIG. 5). For example, if submitted APM data indicates that a motor drive operating a pump in an oil and gas refinery is not tuned for optimized performance, APM data receiving component 338 can search repository 208 for registered consultants reporting experience in tuning motor drives used in similar applications and industries. If the submitted APM data also includes a vendor or manufacturer of the motor drive, APM data receiving component 338 can further limit its search to those consultants reporting experience with that particular model or manufacturer. Based on the criteria provided by APM data receiving unit 338, repository 208 returns a subset of registered consultants most likely to have the skill set and experience necessary to assist with the identified asset performance issue.

APM data processing receiving 338 can further limit the search according to the asset owner's location. For example, a user can indicate via social network interface 320 that only consultants within a given distance from the facility's location should be returned. It is also recognized that some asset performance issues may not require a site visit by the consultant, but instead can be addressed remotely via a phone or e-mail consultation. In such cases, location of the consultant relative to the facility is not a consideration. Accordingly, social network interface 320 can include inputs allowing a user to indicate whether or not a site visit will be necessary to address the asset performance issue. If the user indicates that no such site visit is necessary, the search performed by APM data receiving component 338 can perform the search with no limitation on consultant location.

In one or more embodiments, the APM data receiving component 338 itself can make a determination as to whether a site visit will be necessary to solve the asset performance problem. This determination can be based on the APM data generated by APM system 322 and submitted by social network interface 320. For example, if the APM data receiving component 338 determines, based on the submitted APM data, that the identified asset performance issue can be addressed with a relatively simple software configuration adjustment that can be performed by the user under the remote guidance of an expert consultant, APM data receiving component 338 may perform the search of repository 208 without limiting the search based on the location of the respective consultants. This automatic determination of whether a site visit is necessary can also take into consideration the user's role, which can also be submitted by the social networking interface 320 together with the APM data. In particular, the APM data receiving component 338 can determine, based on the user's role, whether a likely corrective action is within the scope of the user's level of expertise to perform under the remote guidance of an expert consultant. If APM data processing component determines, based on the user role, that the user is capable of effecting the corrective action with remote guidance, the repository search will be performed without regard to the location of the respective consultants. Alternatively, if APM data receiving component 338 determines that a site visit is likely required to address the asset performance issue given the issue and the user's assumed level of experience, APM data processing component can limit the search to consultants within a defined distance from the user's location.

After a subset of suitable consultants has been identified as described above, the subset can optionally be passed to a filtering component 342. Filtering component 342 can perform additional filtering on the subset based on supplemental criteria provided by the asset owner. For example, social network interface 320 can include inputs that allow a user to enter such preferences as preferred consultants, maximum distance of the consultant from the plant, a minimum number of jobs performed by the consultant in the particular technical category for which assistance is needed, a minimum customer feedback rating associated with the consultant, and other such user preferences. A user can also specify that the search should only return consultants having third-party certifications in a given technical area or with a particular brand of equipment. Filtering component 342 can perform filtering on the retrieved subset of consultants based on one or more of these user preferences.

According to one or more embodiments, the selected subset of consultants can be submitted to a ranking component 358 prior to delivery to the asset owner. Ranking component 358 can order the subset of consultants according to default or user-defined sorting criteria. For example, ranking component 358 can order the subset based on a degree of suitability calculated for each consultant with respect to the particular asset performance issue to be addressed. This calculated degree of suitability can be based on such factors as the consultant's reported level of experience with the particular performance issue (as recorded in data fields 526 or 546 of the data structure in FIG. 5), a reported number of similar jobs performed by the consultant in the past (data fields 528, 540, and 548), customer ratings for the consultant, or third-party certifications received by the consultant. In addition or alternatively, the returned list of consultants can be ranked according to proximity of the respective consultants to the user. Ranking component 358 can also order the subset based on user-defined sorting criteria submitted through social network interface 320. For example, the asset owner can pre-identify one or more preferred consultants, and this preferred consultant information can be stored by the social networking system 356 and associated with the asset owner. When the user submits a request through the social networking interface 320, the ranking component 358 can order the returned list of consultants such that any preferred consultants are listed first. The particular sorting criteria to be employed by the ranking component 358 can be specified by the asset owner through the social network interface 320.

After a list of suitable consultants has been retrieved from repository 208 (and optionally filtered and ranked by the filtering component 342 and ranking component 358, respectively), the list is delivered to the social network interface 320 for presentation to the user. Each item in the list can include such information as the consultant's name and location, contact information, and/or customer satisfaction ratings. Testimonials submitted by previous customers (or links thereto) can also be provided for one or more consultants. The list can also include information relevant to the consultants' experience with the particular asset performance issue to be addressed, such as the number of similar jobs performed by the consultant or third-party certifications earned by the consultant for the particular asset in question. Based on the information provided in the consultant list, the asset owner can make an informed selection of one or more suitable consultants to engage for assistance with addressing the asset performance issue identified by APM system 322.

The above disclosure illustrates how asset performance management data generated by APM system 322 can be used to intelligently match a particular asset performance problem or inefficiency with one or more expert consultants (e.g., technical support groups, system integrators, engineering contractors, etc.) having requisite knowledge and experience to assist with the problem. As discussed, a list of suitable consultants compiled in accordance with the techniques described above can be presented to a user via social network interface 320. This list can include supplemental data for each consultant, with particular emphasis on the consultant's experience with the asset performance issue of interest, which can assist the asset owner in making an informed selection of a suitable consultant with whom to network for assistance in dealing with the problem.

In addition to these features, one or more embodiments of the social networking system described herein can facilitate transmission of the APM data generated by an asset owner's APM system 322 to a selected consultant. That is, once the asset owner has selected a consultant for possible engagement from the list generated as described above, the APM data can be transmitted to the selected consultant in order to communicate the nature of the asset performance problem. By providing a means to send the automatically generated APM data to a consultant, the present invention can significantly reduce the knowledge burden on the asset owner and mitigate the difficulties experienced when a client lacking technical understanding of a particular automation asset attempts to convey the nature of a technical problem to an outside consultant.

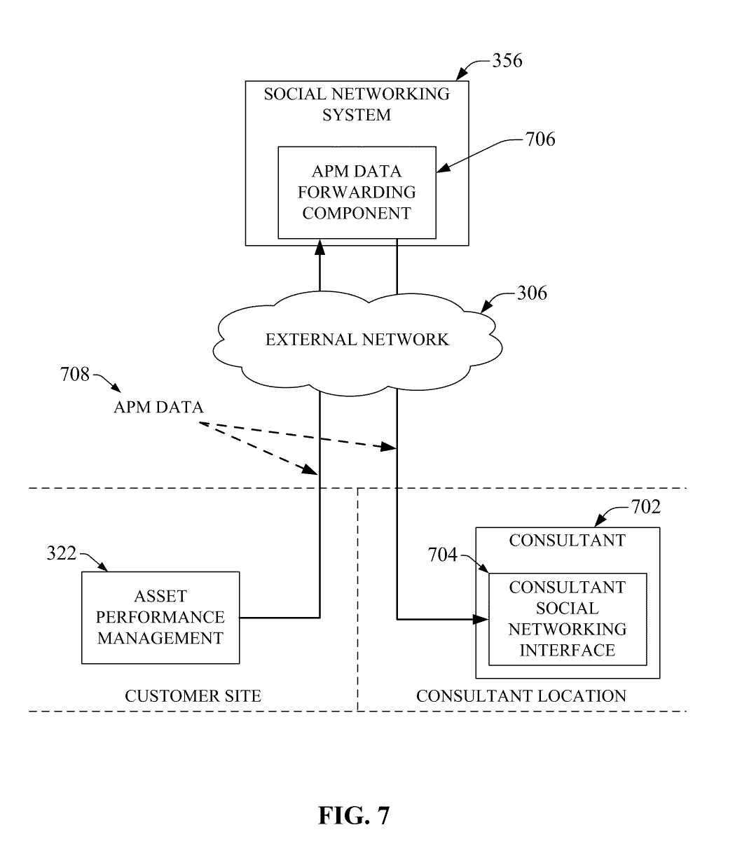

FIG. 7 illustrates an exemplary system for conveying APM data to a consultant according to one or more embodiments of the present invention. After an asset owner (e.g., a plant manager, engineer, technician, etc.) has selected a consultant 702 from the list generated as described above, the asset owner can direct APM system 322 to convey at least a portion of the APM data 708 to the selected consultant 702. Instructions to send the APM analysis data 708 can be entered through the social network interface 320. According to one exemplary embodiment, the APM data 708 is sent from the asset owner's APM system 322 to the social networking system 356, which employs an APM data forwarding component 706 to route the data 708 to the selected consultant 702. In this exemplary embodiment, social networking system 356 acts as a central router for communications between the asset owner and the consultant 702, with the APM data 708 being delivered to a social networking interface 704 at the consultant's office. APM data 708 can also be delivered via email, instant messenger, or other electronic means. In one or more alternative embodiments, the APM data 708 can be delivered from the user's APM system 322 or workstation 316 to the consultant 702 without routing the data through social networking system 356. In yet another alternative embodiment, registered consultants can be provided with a virtual mailbox maintained on the social networking system 356, and communications from potential clients, including APM data 708, can be delivered to the consultant's virtual mailbox. The consultant can then be notified of the communication upon logging into the social networking system 356.

In another exemplary embodiment, APM data forwarding component 706 can forward the APM data 708 to all consultants on the list of suitable consultants once the list is compiled by social networking system 356. In such an embodiment, an asset owner need not select a consultant from the list in order to forward the APM data 708. Instead, all registered consultants determined to have sufficient expertise to assist with the asset performance issue are provided with the APM data 708 (together with any relevant contextual data) describing the asset performance issue. The consultants can then use this APM data 708 to estimate a number of hours, on-site time, expenses, etc. required to assist with the asset performance issue. In this way, the qualifying consultants can refer to the APM data generated at the client site to prepare accurate quotes for bidding purposes, and deliver these quotes to the asset owner for consideration. Such embodiments can advantageously automate many of the steps inherent in the process of collecting bids for engineering services.

Advantageously, the APM data forwarding component 706 can deliver the APM data 708 to the selected consultants in a format commensurate with the consultants' presumed degree of expertise. This format can be different than that used to visualize the APM data to the asset owner via visualization component 318, which tailors the APM data in accordance with the asset owner's role as discussed supra. For example, if the asset owner is an operator, a low level technician, or a plant manager with limited technical knowledge of assets 332, visualization component 318, being role-aware, can present the APM data generated for assets 332 in a format that can be understood by users having those roles (e.g., simple graphics at an appropriate degree of detail, emailed or rendered text messages, high-level status diagrams, etc). When the APM data is forwarded to an expert consultant, the APM data forwarding component 706 can deliver the APM data 708 in a more descriptive and technically detailed format given the consultants' presumed degree of asset expertise. Leveraging automatically generated APM data in this fashion can eliminate the communication barrier between an inexperienced asset owner and a consultant providing assistance with the asset, removing the burden on the asset owner to provide technical specifics of a particular asset performance problem.

Integrating the model-based analytical capabilities of APM system 322 with the social networking aspects described above can simplify communication between a potentially inexperienced asset owner and consultants engaged to provide assistance with configuration or repair of the assets. By leveraging the collective best practices, knowledge, and expertise encoded in the asset application models 324, a refined set of performance metrics can be automatically collected for the assets, and performance problems or inefficiencies associated therewith can be identified. The social networking architecture can direct the asset owner to one or more consultants capable of assisting with the identified issues. Moreover, the performance metrics generated by the APM system can be provided to one or more selected consultants to lessen the burden on an inexperienced asset owner to convey the nature of the asset performance problem to the consultant. These techniques can significantly reduce the need for in-house asset expertise within a facility, thus providing assurance that automation assets can be easily maintained even if experienced personnel leave the plant after the assets are deployed.

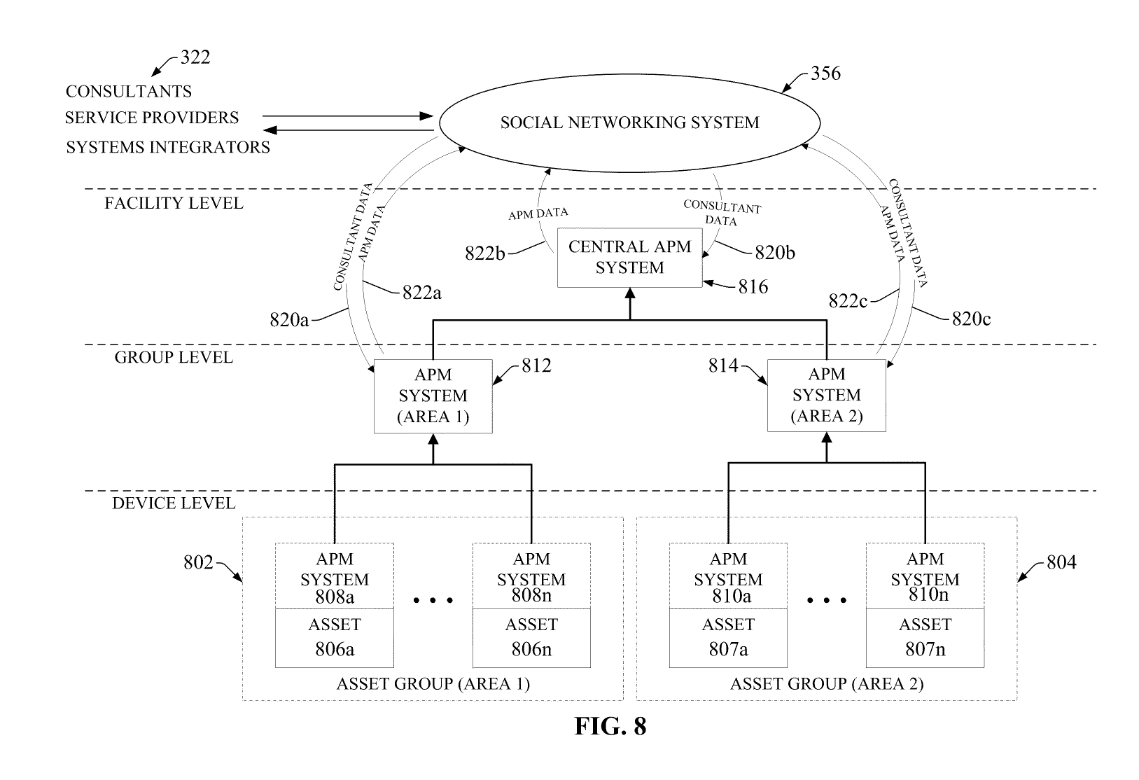

Although APM system 322 is depicted and described as a single stand-alone component monitoring a set of automation assets 332, additional embodiments are contemplated wherein multiple APM systems are configured to operate in a coordinated fashion. According to such embodiments, multiple APM systems can monitor performance of respective assigned assets, and serve data to one another to facilitate a holistic approach to model-based asset performance monitoring. FIG. 8 depicts an exemplary hierarchical architecture of APM systems according to one or more embodiments of the present application. Automation assets 806a-806n and 807a-807n operate within a facility to carry out one or more control and/or monitoring applications. The assets can be categorized into asset groups 802 and 804, where assets 806a-806n comprise group 802, and assets 807a-807n comprise group 804. Asset groups 802 and 804 can each correspond with a particular automation system, area of the facility, or any other conceivable grouping. APM systems 808a-808n and 810a-810n each provide performance monitoring on an individual asset. These APM systems carry out comparable functionality to that described above in connection with APM system 322. In particular, APM systems 808a-808n and 810a-810n capture, validate, and analyze data from and about the assets based on a configured model of the assets, as described above. According to one or more embodiments particular to a motor control application, APM systems 808a-808n and 810a-810n, which operate at a device level of the facility, can coincide with or be embedded in motor control and monitoring equipment such as drives, contactors, overload relays or other devices directly connected to the motor terminals.

Performance data collected and/or generated by APM systems 808a-808n and 810a-810n (relating to performance of assets 806a-806n and 807a-807n, respectively) can be presented to a user as discussed above (e.g. using visualization component 318). Additionally or alternatively, this APM data can be provided to APM systems 812 and 814. Whereas APM systems 808a-808n and 810a-810n each perform asset performance monitoring and analysis for an individual asset, APM systems 812 and 814 are configured to perform monitoring and analysis for a group of assets. In the exemplary embodiment illustrated in FIG. 8, APM system 812 monitors the asset group corresponding with Area 1, while APM system 814 monitors the asset group corresponding with Area 2. APM systems 812 and 814 thus operate at a group level of the facility. As with the device level APM systems, group level APM systems 812 and 814 can render results of their APM analysis of asset groups 802 and 804 to a display device (e.g. visualization component 318), or deliver the results to another APM system in the hierarchy. At the top of the hierarchy, a central APM system 816 can receive data from the lower level distributed APM systems (or directly from the assets themselves), and employ this data to carry out asset performance monitoring and analysis for the facility as a whole.

It is to be appreciated that the hierarchical distribution of APM systems is not limited to the three-tier architecture depicted in FIG. 8, and that the APM systems can be configured in an architecture having any conceivable number off hierarchical levels. Moreover, facility level APM system 816 need not be the top-most system in the hierarchy. In some exemplary embodiments, an enterprise level APM system can receive and process APM data from multiple related facilities and perform asset performance management for the multiple facilities as a whole.

According to an aspect of the present invention, each APM system in the hierarchy can interact with social networking system 356 in the manner described supra in connection with APM system 322. That is, APM data 822a, 822b, and/or 822c can be submitted to the social networking system 356 from any of APM systems 812, 814, or 816. In response, social networking system 356 can search repository 208 for consultants capable of assisting with an asset performance issue identified by the submitted APM data, and return consultant data 820a, 820b, or 820c containing information relating to one or more suitable consultants. Although not illustrated, it is to be appreciated that device level APM systems 808a-808n and 810a-810n can also interact with social networking system 356 in this manner. Moreover, APM data can be delivered to one or more selected consultants from any of the hierarchical APM systems via social networking system 356 according to one or more embodiments.

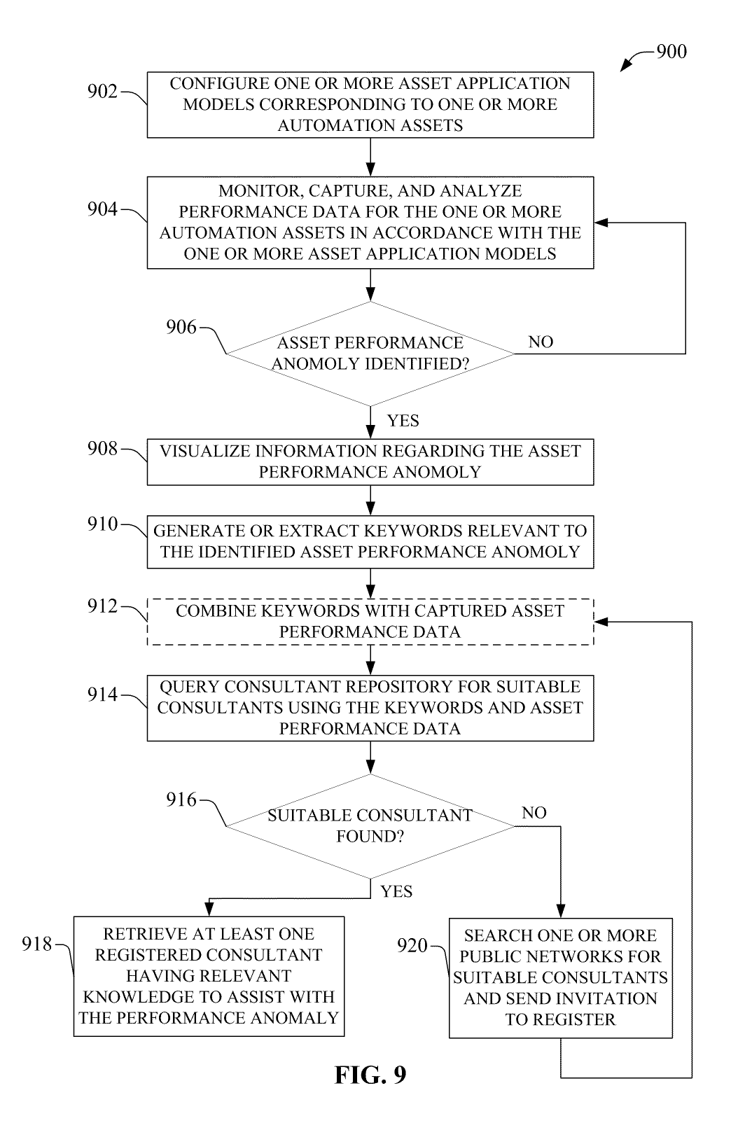

FIGS. 9-13 illustrate various methodologies in accordance with the claimed subject matter. While, for purposes of simplicity of explanation, the one or more methodologies shown herein are shown and described as a series of acts, it is to be understood and appreciated that the subject innovation is not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation. Furthermore, interaction diagram(s) may represent methodologies, or methods, in accordance with the subject disclosure when disparate entities enact disparate portions of the methodologies. Further yet, two or more of the disclosed example methods can be implemented in combination with each other, to accomplish one or more features or advantages described herein.

FIG. 9 illustrates an example methodology 900 for identifying suitable technical consultants to assist with an asset performance issue in accordance with an aspect of the present innovation. At 902, one or more asset application models are configured. These asset application models correspond with one or more assets or asset applications to be monitored, and are used to determine appropriate asset performance data for analysis and appropriate analytics operations to be performed on the asset data. At 904, performance data for the one or more assets is monitored, captured, and analyzed in view of the one or more asset application models. By employing the asset application models to monitor and analyze the asset data, high value performance monitoring metrics can be obtained. At 906, a determination is made as to whether the analysis identifies an asset performance anomaly. An asset performance anomaly can comprise an improperly functioning or non-functioning asset, a configuration issue preventing the asset(s) from performing at optimal efficiency, a detected degradation in asset performance over time, or other such performance problems.

If no asset performance anomaly is identified, the methodology returns to step 904, and the monitoring, capturing, and analyzing of the asset performance data continues. Alternatively, if an asset performance anomaly is identified, the methodology proceeds to step 908, wherein information regarding the asset performance anomaly is visualized. At 910, keywords describing the identified asset performance anomaly are generated. This can be generated, for example, by the asset performance management system performing the monitoring, or by a separate social networking component that prepares APM data for submission to the social networking system. At 912, as an optional step, the generated or extracted keywords can be combined with all or a portion of asset performance data captured by the monitoring step 904. This asset performance data can be used together with the generated keywords to refine a subsequent consultant search.

At 914, the keywords and, optionally, the asset performance data are used to perform a query to identify suitable consultants having requisite knowledge and experience to assist with the identified performance anomaly. This query can be performed by submitting the keywords and/or asset performance data to a social networking system comprising a repository of registered consultants. The social networking system can reside outside a local network on which the automation assets reside. In such an embodiment, the keywords and asset performance data can be submitted to the social networking system through an external network, such as the Internet. In one or more alternative embodiments, the social networking system can reside on the same network as the automation assets. At 916, a determination is made as to whether the query discovered one or more suitable consultants within the consultant repository. If at least one registered consultant was discovered having knowledge to assist with the identified asset performance problem, the at least one registered consultant is retrieved in response to the query at 918. The selection of the at least one consultant is based on the submitted keywords and/or asset performance data submitted at step 914. If no suitable consultants are discovered in the registry, the method moves to 920, where a search is made of one or more public networks or databases where appropriate consultants may be registered, and an invitation to register with the consultant repository is sent to one or more suitable consultants found as a result of this search. The method then moves back to step 912, and a subsequent search of the consultant repository can be performed.

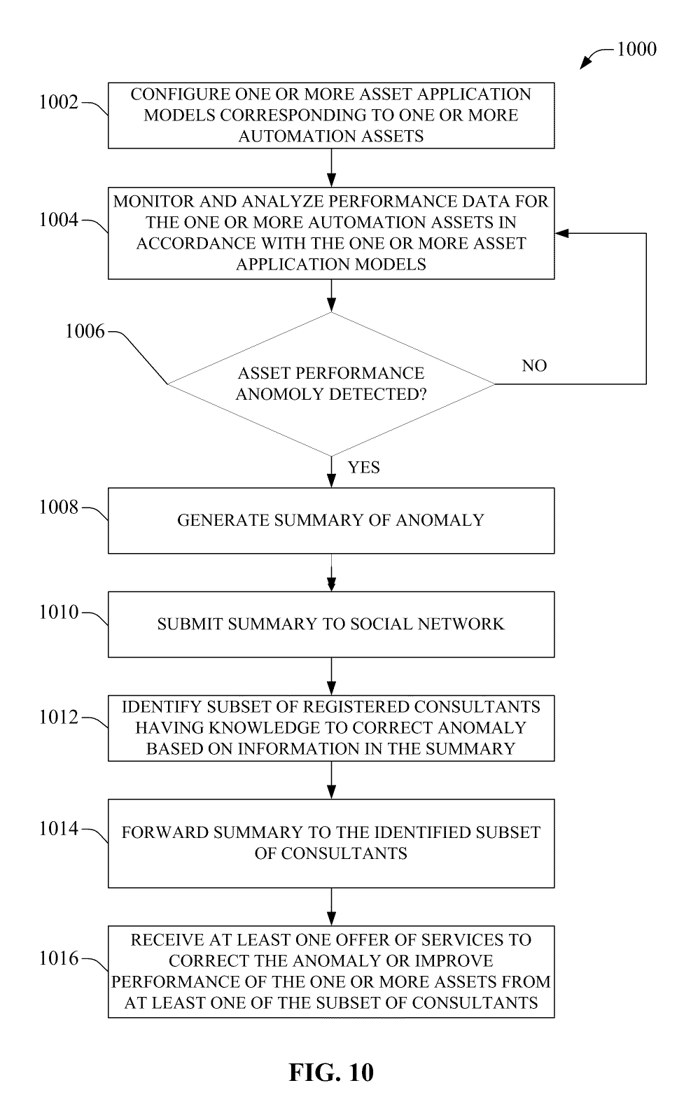

FIG. 10 illustrates a methodology 1000 for employing asset performance data to solicit for offers of service from one or more technical consultants. At 1002, one or more asset application models are configured for one or more automation assets, as described above. At 1004, the one or more asset application models are used to monitor and analyze performance data for the one or more automation assets. At 1006, a determination is made as to whether an asset performance anomaly is detected based on the analysis performed at 1004. If no such anomaly is detected, the flow returns to 1004, and the monitoring and analysis continues. Alternatively, if an asset performance anomaly is identified, a summary of the anomaly is generated at 1008. This summary can include relevant keywords generated or extracted from the monitored performance data. The summary can also include all or a portion of the performance data itself, as recorded by the monitoring step at 1004.

At 1010, the summary is submitted to a social network to facilitate identifying and networking with consultants having a sufficient level of skill and experience in addressing the identified anomaly or sufficiently similar asset performance issues. The social network can include a repository of registered consultants that stores a detailed accounting of each consultant's areas of expertise and/or relevant job experiences. At 1012, the submitted summary is used to identify a subset of registered consultants having sufficient knowledge to address the identified anomaly. The techniques used to identify suitable consultants can be similar to those described supra. After the suitable subset of consultants has been identified, the summary is forwarded to the identified subset of consultants for review at 1014. In this way, potential consultants can be provided with an automatically generated summary of the asset anomaly or problem with which a client desires assistance, and can use the summary to determine whether to submit an offer of service, estimate a number of hours needed to correct the anomaly, prepare a quote for the services, etc. At 1016, based on information contained in the summary, at least one offer of services to correct the anomaly or to generally improve performance of the assets can be received from at least one of the identified consultants in the subset. By providing the prospective consultants with automatically generated and summarized asset performance information, consultants can provide more accurate quotes and timeline estimations for the job of assisting with the asset performance anomaly. Moreover, inexperienced asset owners are relieved of the burden of conveying a detailed explanation of the problem to consultants, thereby eliminating the communication barrier that often exists between an untrained asset owner and expert consultants.

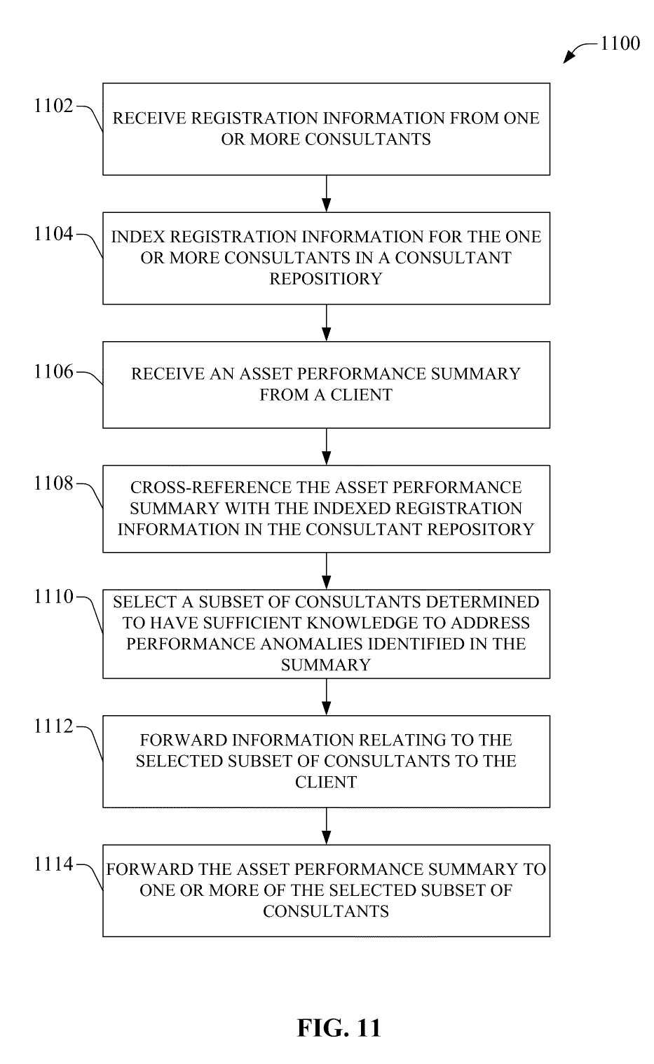

FIG. 11 depicts a methodology 1100 for registering a consultant with a social networking system and locating the consultant for engagement with customers (e.g., asset owners). At 1102, registration information is received from one or more consultants. This registration information can include, for example, the respective consultants' areas of expertise, location, and/or degree of experience in one or more technical categories. At 1104, the registration information can be indexed in a consultant repository. At 1106, an asset performance summary can be received from a client. This asset performance summary can be generated in accordance with the systems and methods described above, and can include such information as keywords relating to one or more asset performance anomalies, performance data collected from the assets, and/or a manufacturer of one or more of the assets.

At 1108, the received asset performance summary can be cross-referenced with the indexed registration information stored in the consultant repository. Based on this cross-referencing, a subset of consultants determined to have sufficient knowledge to assist with the summarized asset performance anomalies are selected at 1110. At 1112, information relating to the selected subset of consultants are forwarded to the client. This information can be delivered in the form of a ranked and filtered list of suitable consultants, including information on each consultant's experience, areas of expertise, and/or certifications with particular focus on the consultants' experience with the type of asset performance anomaly identified in the summary. At 1114, the asset performance summary used to select the subset of consultants can be forwarded to one or more of the selected consultants in order to convey the nature of the asset performance problem to be addressed. In this way, the consultants can be provided with a clear and detailed technical description of the asset performance issue to be addressed that can be used for job quoting purposes.

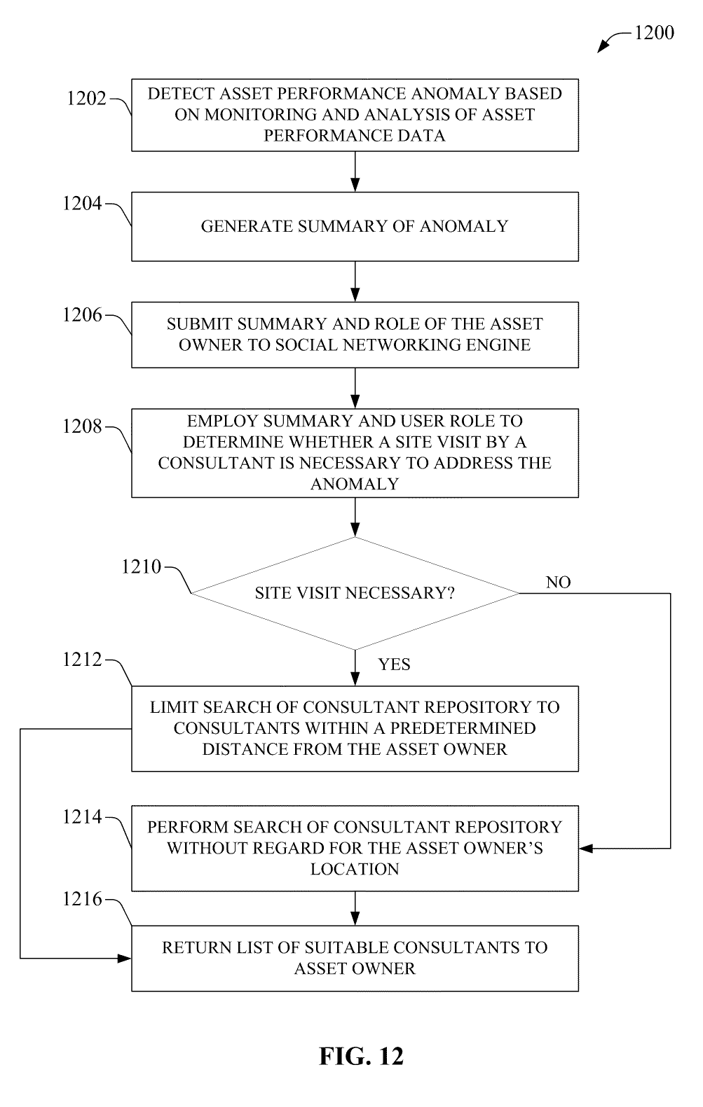

FIG. 12 depicts a methodology 1200 for automatically refining a consultant search based on an asset owner's role and location. At 1202, an asset performance anomaly is detected based on APM monitoring and analysis in accordance with the techniques described supra. At 1204, a summary of the asset performance anomaly is generated. As discussed above, this summary can include generated or extracted keywords relating to the asset performance anomaly, and/or performance data recorded for the assets in accordance with one or more asset application models. At 1206, the summary is submitted to a social networking engine together with user role information associated with the owner of the asset (e.g., the user seeking to engage a consultant to assist with correcting the performance anomaly).

At 1208, a determination is made as to whether a site visit by a consultant is necessary to address the anomaly based on an analysis of the summary and user role information. In one or more exemplary embodiments, this determination can be made by ascertaining a likely corrective action for the performance anomaly identified by the summary, and determining whether this corrective action is within the abilities of the asset owner to carry out given the role associated with the asset owner. If it is determined that the asset owner is capable of carrying out the corrective action with remote guidance from an expert consultant (e.g., if the user's role suggests a degree of hands-on knowledge of the assets), it can be assumed that the asset performance issue does not require a site visit by a consultant. Alternatively, if it is determined that the corrective action cannot be performed by the asset owner (such as when the user's role indicates an insufficient level of direct experience with the asset), a site visit is assumed to be required.

If a site visit is determined to be necessary at 1210, a subsequent search of a consultant repository is limited to consultants within a predetermined distance from the asset location at 1212. This ensures that only suitable consultants within a feasible distance from the asset location are returned as a result of the repository search. Alternatively, if it is determined that a site visit is not necessary (e.g. if the asset owner can be guided through the process of correcting the asset performance problem remotely via telephone or email), the search of the consultant repository is performed without limiting the search based on location at 1214. By removing the location restriction in cases where a site visit by a consultant is not necessary, a broader range of consultants for potential engagement can be delivered to the asset owner.

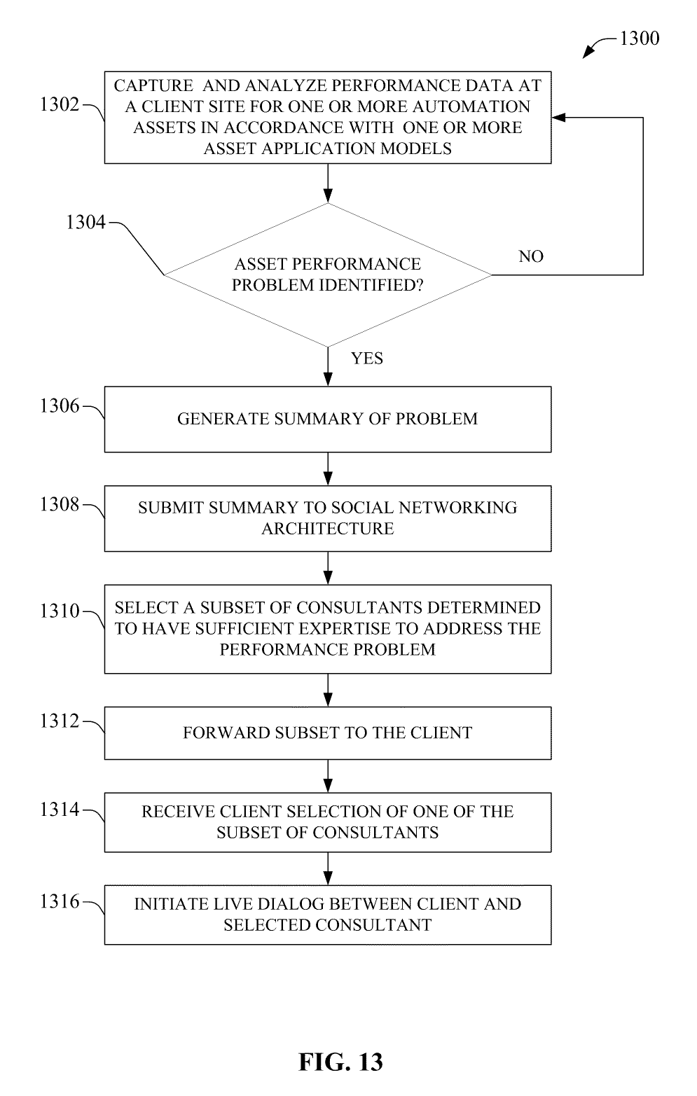

FIG. 13 illustrates a methodology 1300 for initiating a live dialog with an expert consultant for assistance with an asset performance problem. At 1302, asset performance data is captured and analyzed at a client site in accordance with one or more asset application models, as described supra. At 1304, a determination is made as to whether the analysis identifies an asset performance problem. If an asset performance problem is not identified, the method returns to 1302 and the capturing and analyzing continues. If an asset performance problem is identified, a summary of the problem is generated at 1306. The summary can include, for example, keywords relevant to the problem and/or a possible corrective measure. The summary can also include at least a portion of the asset performance data captured at step 1302. At 1308, the summary is submitted to a social networking architecture. Based on information in the summary, a subset of consultants determined to have sufficient expertise to address the asset performance problem is selected at 1310. At 1312, this subset of suitable consultants is forwarded to the client. A selection of one of the subset of consultants is then received from the client at 1314. At 1316, a live dialog is initiated between the client and the selected consultant. This live dialog can be performed via virtually any communication means, such as instant messenger, electronic chat, voice over IP (VoIP), or other such communication channels. A transcript of the subsequent live dialog can be recorded for future reference.

Embodiments, systems and components described herein, as well as industrial control systems and industrial automation environments in which various aspects set forth in the subject specification can be carried out, can include computer or network components such as servers, clients, programmable logic controllers (PLCs), communications modules, mobile computers, wireless components, control components and so forth which are capable of interacting across a network. Computers and servers include one or more processors—electronic integrated circuits that perform logic operations employing electric signals—configured to execute instructions stored in media such as random access memory (RAM), read only memory (ROM), a hard drives, as well as removable memory devices, which can include memory sticks, memory cards, flash drives, external hard drives, and so on.

Similarly, the term PLC as used herein can include functionality that can be shared across multiple components, systems, and/or networks. As an example, one or more PLCs can communicate and cooperate with various network devices across the network. This can include substantially any type of control, communications module, computer, Input/Output (I/O) device, sensor, actuator, and human machine interface (HMI) that communicate via the network, which includes control, automation, and/or public networks. The PLC can also communicate to and control various other devices such as I/O modules including analog, digital, programmed/intelligent I/O modules, other programmable controllers, communications modules, sensors, actuators, output devices, and the like.

The network can include public networks such as the internet, intranets, and automation networks such as control and information protocol (CIP) networks including DeviceNet and ControlNet. Other networks include Ethernet, DH/DH+, Remote I/O, Fieldbus, Modbus, Profibus, CAN, wireless networks, serial protocols, and so forth. In addition, the network devices can include various possibilities (hardware and/or software components). These include components such as switches with virtual local area network (VLAN) capability, LANs, WANs, proxies, gateways, routers, firewalls, virtual private network (VPN) devices, servers, clients, computers, configuration tools, monitoring tools, and/or other devices.

In this application, the word “exemplary” is used to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Moreover, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Various aspects or features described herein may be implemented as a method, apparatus, or article of manufacture using standard programming and/or engineering techniques. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks [e.g., compact disk (CD), digital versatile disk (DVD) . . . ], smart cards, and flash memory devices (e.g., card, stick, key drive . . . ).

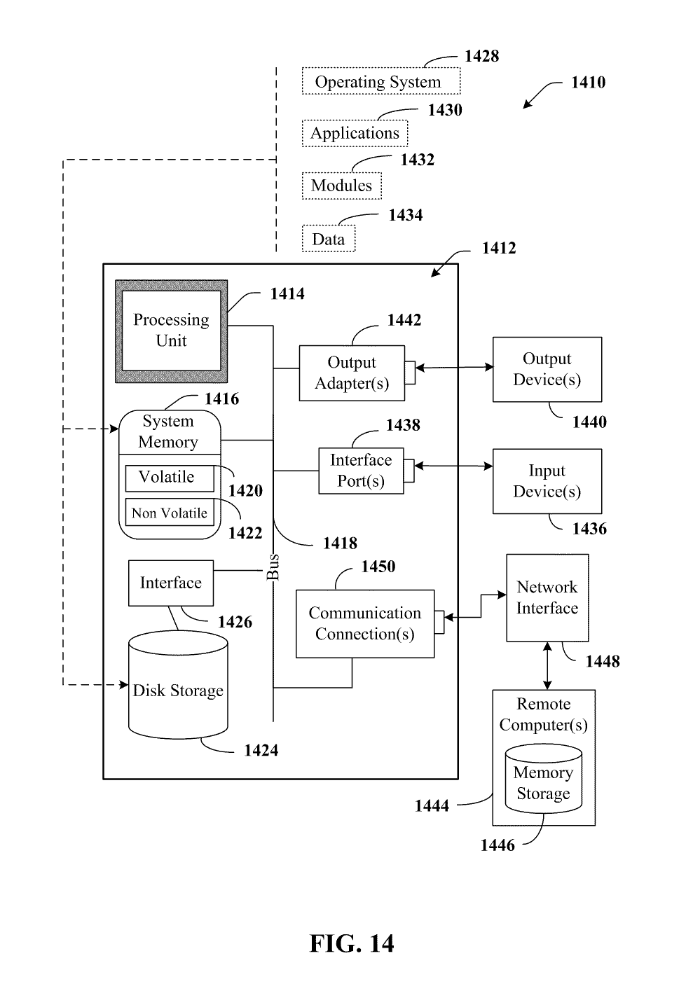

With reference to FIG. 14, an example environment 1410 for implementing various aspects of the aforementioned subject matter, including retaining documentation natively within memory of an industrial controller, includes a computer 1412. The computer 1412 includes a processing unit 1414, a system memory 1416, and a system bus 1418. The system bus 1418 couples system components including, but not limited to, the system memory 1416 to the processing unit 1414. The processing unit 1414 can be any of various available processors. Dual microprocessors and other multiprocessor architectures also can be employed as the processing unit 1414.

The system bus 1418 can be any of several types of bus structure(s) including the memory bus or memory controller, a peripheral bus or external bus, and/or a local bus using any variety of available bus architectures including, but not limited to, 8-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1416 includes volatile memory 1420 and nonvolatile memory 1422. The basic input/output system (BIOS), containing the basic routines to transfer information between elements within the computer 1412, such as during start-up, is stored in nonvolatile memory 1422. By way of illustration, and not limitation, nonvolatile memory 1422 can include read only memory (ROM), programmable ROM (PROM), electrically programmable ROM (EPROM), electrically erasable PROM (EEPROM), or flash memory. Volatile memory 1420 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1412 also includes removable/non-removable, volatile/non-volatile computer storage media. FIG. 14 illustrates, for example a disk storage 1424. Disk storage 1424 includes, but is not limited to, devices like a magnetic disk drive, floppy disk drive, tape drive, Jaz drive, Zip drive, LS-100 drive, flash memory card, or memory stick. In addition, disk storage 1324 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1424 to the system bus 1418, a removable or non-removable interface is typically used such as interface 1426.

It is to be appreciated that FIG. 14 describes software that acts as an intermediary between users and the basic computer resources described in suitable operating environment 1410. Such software includes an operating system 1428. Operating system 1428, which can be stored on disk storage 1424, acts to control and allocate resources of the computer system 1412. System applications 1430 take advantage of the management of resources by operating system 1428 through program modules 1432 and program data 1434 stored either in system memory 1416 or on disk storage 1424. It is to be appreciated that the subject invention can be implemented with various operating systems or combinations of operating systems.

A user enters commands or information into the computer 1412 through input device(s) 1436. Input devices 1436 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1414 through the system bus 1418 via interface port(s) 1438. Interface port(s) 1438 include, for example, a serial port, a parallel port, a game port, and a universal serial bus (USB). Output device(s) 1440 use some of the same type of ports as input device(s) 1436. Thus, for example, a USB port may be used to provide input to computer 1412, and to output information from computer 1412 to an output device 1440. Output adapter 1442 is provided to illustrate that there are some output devices 1440 like monitors, speakers, and printers, among other output devices 1440, which require special adapters. The output adapters 1442 include, by way of illustration and not limitation, video and sound cards that provide a means of connection between the output device 1440 and the system bus 1418. It should be noted that other devices and/or systems of devices provide both input and output capabilities such as remote computer(s) 1444.

Computer 1412 can operate in a networked environment using logical connections to one or more remote computers, such as remote computer(s) 1444. The remote computer(s) 1444 can be a personal computer, a server, a router, a network PC, a workstation, a microprocessor based appliance, a peer device or other common network node and the like, and typically includes many or all of the elements described relative to computer 1412. For purposes of brevity, only a memory storage device 1446 is illustrated with remote computer(s) 1444. Remote computer(s) 1444 is logically connected to computer 1412 through a network interface 1448 and then physically connected via communication connection 1450. Network interface 1448 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1450 refers to the hardware/software employed to connect the network interface 1448 to the bus 1418. While communication connection 1450 is shown for illustrative clarity inside computer 1412, it can also be external to computer 1412. The hardware/software necessary for connection to the network interface 1448 includes, for exemplary purposes only, internal and external technologies such as, modems including regular telephone grade modems, cable modems and DSL modems, ISDN adapters, and Ethernet cards.

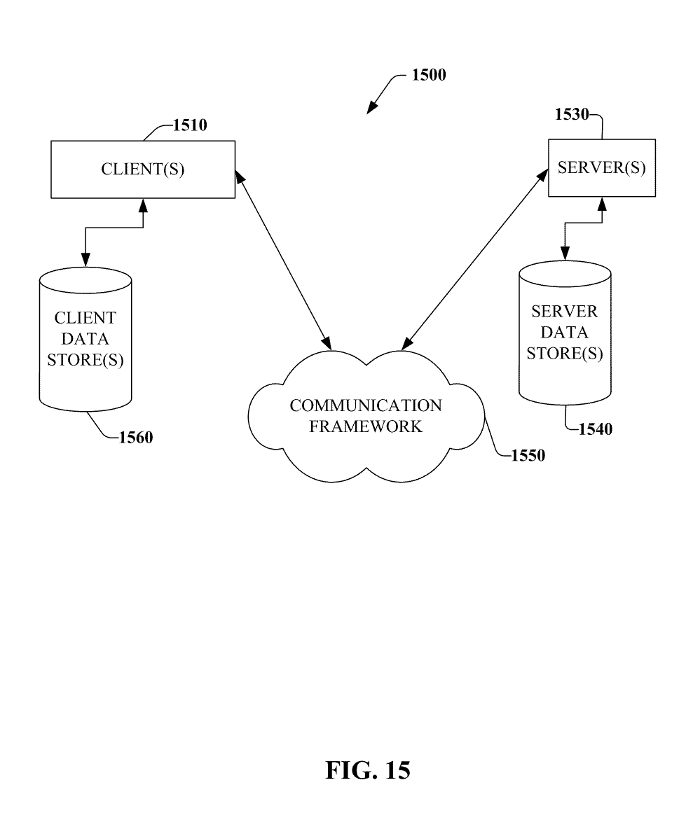

FIG. 15 is a schematic block diagram of a sample-computing environment 1500 with which the disclosed subject matter can interact. The system 1500 includes one or more client(s) 1510. The client(s) 1510 can be hardware and/or software (e.g., threads, processes, computing devices). The system 1500 also includes one or more server(s) 1530. The server(s) 1530 can also be hardware and/or software (e.g., threads, processes, computing devices). The servers 1530 can house threads to perform transformations by employing the subject invention, for example. One possible communication between a client 1510 and a server 1530 can be in the form of a data packet adapted to be transmitted between two or more computer processes. The system 1500 includes a communication framework 1550 that can be employed to facilitate communications between the client(s) 1510 and the server(s) 1530. The client(s) 1510 are operably connected to one or more client data store(s) 1560 that can be employed to store information local to the client(s) 1510. Similarly, the server(s) 1530 are operably connected to one or more server data store(s) 1540 that can be employed to store information local to the servers 1530.

What has been described above includes examples of the subject innovation. It is, of course, not possible to describe every conceivable combination of components or methodologies for purposes of describing the disclosed subject matter, but one of ordinary skill in the art may recognize that many further combinations and permutations of the subject innovation are possible. Accordingly, the disclosed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the disclosed subject matter. In this regard, it will also be recognized that the disclosed subject matter includes a system as well as a computer-readable medium having computer-executable instructions for performing the acts and/or events of the various methods of the disclosed subject matter.

In addition, while a particular feature of the disclosed subject matter may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

1. A system that facilitates social networking between an automation asset owner and a consultant, comprising:
a consultant repository configured to store information relating to a plurality of consultants; and
an asset performance management (APM) data receiving component configured to receive APM data identifying at least one asset performance anomaly and to identify a subset of the plurality of consultants having sufficient expertise to address the asset performance anomaly.

2. The system of claim 1, wherein the consultant repository is configured to store at least one data record associated with a corresponding consultant, the data record including information relating to at least one of an industry, an asset type, or an asset manufacturer with which the corresponding consultant has work experience.

3. The system of claim 1, wherein the APM data comprises at least one keyword relating to the asset performance anomaly or a countermeasure associated therewith.

4. The system of claim 1, further comprising an APM system configured to automatically generate the APM data based on analysis of asset performance data collected for at least one plant, process, or automation asset.

5. The system of claim 4, wherein the APM system is configured to monitor, capture, and analyze the asset performance data in accordance with at least one asset application model.

6. The system of claim 5, further comprising an APM model library configured to store a set of predefined asset application models, wherein the at least one asset application model is selected and retrieved from the set of predefined asset application models for use in the APM system.

7. The system of claim 4, wherein the APM system is configured to analyze the asset performance data in view of at least one of historical asset performance data or context data relating to the at least one automation asset.

8. The system of claim 1, further comprising a filtering component that performs additional filtering on the subset of consultants based on user-defined filtering criteria.

9. The system of claim 1, further comprising a ranking component that orders the subset of consultants based on at least one of default sorting criteria or user-defined sorting criteria.

10. The system of claim 1, further comprising a social network interface configured to receive a first input initiating submission of the APM data to the APM data receiving component, and to render the subset of the plurality of consultants.

11. The system of claim 10, wherein the social network interface is further configured to receive a second input identifying a selected consultant of the subset of the plurality of consultants.

12. The system of claim 11, further comprising an APM data forwarding component configured to transmit at least a portion of the APM data to an address associated with the selected consultant in response to the second input.

13. The system of claim 1, further comprising an APM data forwarding component configured to transmit at least a portion of the APM data to the subset of the plurality of consultants.

14. A method for discovering and interacting with one or more expert consultants, comprising:
receiving asset performance management (APM) data identifying at least one asset performance problem;
searching a repository of consultant information relating to a plurality of consultants using at least a portion of the APM data as search criteria;
identifying a subset of the plurality of consultants whose corresponding consultant information indicates an ability to assist with the at least one asset performance problem; and
providing a list identifying the subset of the plurality of consultants.

15. The method of claim 14, further comprising automatically generating the APM data based on an analysis of asset performance data collected from at least one automation asset.

16. The method of claim 15, further comprising performing the analysis of the asset performance data in accordance with one or more asset application models configured for the at least one automation asset.

17. The method of claim 15, wherein the automatically generating comprises generating at least one keyword relating to the at least one asset performance problem based on the analysis of the asset performance data.

18. The method of claim 15, further comprising performing the analysis of the asset performance data in view of at least one of historical asset performance data or context data relating to the at least one automation asset.

19. The method of claim 14, further comprising:
receiving a first input identifying a selected consultant of the subset of consultants; and
sending at least a portion of the APM data to the selected consultant in response to the receiving.

20. A system for soliciting for assistance with an asset performance issue, comprising:
means for monitoring performance data for one or more automation assets in accordance with at least one automation asset model;
means for generating asset performance management (APM) data identifying an asset performance issue based on the performance data and the at least one automation asset model;
means for submitting the APM data to a consultant repository;
means for receiving a list of one or more consultants selected from the consultant repository based on an automated determination of the one or more consultants' level of expertise with respect to the asset performance issue.
